(19) United States
(12) Patent Application Publication
(10) Pub. No.: US 2007/0258624 A1
(43) Pub. Date: Nov. 8, 2007

(54) Mark Position Detection Device, Design Method, and Evaluation Method

(75) Inventor: Daisaku Mochida, Kanagawa-ken (JP)

Correspondence Address: ARENT FOX LLP, 1050 CONNECTICUT AVENUE, N.W., SUITE 400, WASHINGTON, DC, 20036, US

(73) Assignee: NIKON CORPORATION, Chiyoda-ku, Tokyo (JP)

(21) Appl. No.: 11/661,396

(22) PCT Filed: Oct. 17, 2005
(86) PCT No.: PCT/JP05/19049

§ 371 Date: Apr. 27, 2007

(30) Foreign Application Priority Data
Oct. 29, 2004 (JP) 2004-316642

(51) Int. Cl. G06K 9/00

(52) U.S. Cl. 382/106

(57) ABSTRACT

An object is to constitute a mark position detection device with high measurement accuracy. Further, another object is to provide an evaluation method capable of evaluating characteristics of an image formation optical system with high sensitivity. Accordingly, the mark position detection device has the image formation optical system that causes the imaging of light reflected from a mark constituted of a plurality of steps formed on a substrate; an image pickup part that fetches an image formed by the image formation optical system; and a detection part that detects positions of the steps based on an output signal from the image pickup part wherein, when wavefront aberration of the image formation optical system is expressed by Zernike polynomials, an amount of change of Z4 among the polynomials due to an object height amounts to a prescribed range according to a position detection precision of the mark position detection device.

### CROSS-REFERENCE TO RELATED APPLICATION

This application is a U.S. National Stage application claiming the benefit of prior filed International Application Number PCT/JP2005/019049, filed Oct. 17, 2005, in which the International Application claims a priority date of Oct. 29, 2004 based on prior filed Japanese Application Number 2004-316642, the entire contents of which are incorporated herein by reference.

1. Technical Field

The present invention relates to a mark position detection device, a design method, and an evaluation method, of an overlay measurement device measuring overlay marks, alignment marks and so on, on an observational substrate such as a semiconductor wafer.

2. Background Art

In a photo lithography process of a semiconductor manufacturing process, it is necessary to measure an overlay misalignment amount between a resist pattern and a foundation pattern formed to manage the process. A device used for this measurement is an overlay measurement device. In this type of device, illumination is irradiated to an observational mark, reflected light from the mark is image-formed to be captured up by a CCD camera and so on, and the overlay misalignment amount is measured via image processes. In recent years, it is necessary to improve a wafer alignment accuracy and an accuracy of the overlay misalignment amount at a time of exposure, in accordance with a miniaturization of a semiconductor device, and required specification for the measurement accuracy of the mark position detection device such as the overlay measurement device becomes severe. Therefore, conventionally, ingenuity to improve the accuracy of the device has been exercised as much as possible by using, for example, an adjustment method disclosed in Patent Document 1.

Patent document 1: Japanese Unexamined Patent Application Publication No. 2002-25879

### DISCLOSURE OF THE INVENTION

Problems to be Solved by the Invention

The above-stated conventional method is a method in which an optimal visual field position of an overlay measurement device is defined. It becomes possible to pull out best performance of a manufactured device by using this method. However, these adjustment methods are just to pull out the performance which is held by the device potentially, and there was a limit that the accuracy cannot be improved no matter how hard the device is adjusted when the performance of the device in itself is bad. Besides, it is necessary to suppress aberration at a design stage in advance, and to suppress manufacturing tolerance within a specification value at the time of manufacturing, in order to improve the performance of the device in itself. However, it is very difficult to completely get over every factor which deteriorates the accuracy of the mark position detection.

An object of the present invention is to search for aberration which affects the accuracy of the mark position detection most, and a kind of distribution held by the aberration when the aberration affects the most, and to constitute a mark position detection device having a high measurement accuracy while focusing attention to this aberration and aberration distribution, in the mark position detection device to solve the above-stated problems. Further, another object of the present invention is to provide an evaluation method capable of evaluating characteristics of an image formation optical system with high sensitivity.

Means for Solving the Problems

A mark position detection device of the present invention includes: an image formation optical system that causes the imaging of light reflected from a mark constituted of a plurality of steps formed on a substrate; a part picking up an image that fetches an image formed by the image formation optical system; and a detection part that detects positions of the steps based on an output signal from the image pickup part wherein, when wavefront aberration of the image formation optical system is expressed by Zernike polynomials, an amount of change due to an object height of Z4 among the polynomials amounts to a prescribed range according to position detection precision of the mark position detection device.

Besides, in the above-stated mark position detection device, the optical system of the image formation part satisfies the following conditional expression,
|−0.0012 ΔX●ΔZ●(a+b)/N.A.|<TIS_{design}
where:
a: Distance from a center up to an outside edge of a TIS measurement mark used (μm);
b: Distance from the center up to an inside edge of the TIS measurement mark used (μm);
N.A: Image formation N.A. of an object side of the image formation part
ΔX: Amount of overlay misalignment in a step detection direction between the center of the measurement mark and a center of an optical axis, due to manufacturing errors and the like (μm);
ΔZ: Difference of a wavefront aberration Zernike coefficient Z4 at object height 30 μm and the optical axis center (m λ)

Here Z4 is a coefficient applied to a function (2ρ²−1),
TIS_{degisn}: Design specification of the overlay misalignment amount when a measurement mark for which the overlay misalignment amount is zero is measured (nm).

Besides, in the above-stated mark position detection device, the optical system of the image formation part satisfies the following conditional expression,
|0.0012●L●ΔZ●(a+b)/N.A.|<ΔTIS_{design}
a: Distance from the center up to the outside edge of the TIS measurement mark used (μm)
b: Distance from the center up to the inside edge of the TIS measurement mark used (μm)
N.A: Image formation N.A. of the object side of the image formation part
L: Size of field of vision (μm)
ΔZ: Difference of the wavefront aberration Zernike coefficient Z4 at object height 30 μm and the optical axis center (m λ)

Here Z4 is the coefficient applied to the function (2ρ²−1),
ΔTIS_{degisn}: Design specification of the TIS flatness (difference of the largest TIS and the smallest TIS) within the field of vision of the device (nm).

A design method for an image formation optical system in a mark position detection device wherein the image formation optical system is designed so as to satisfy the following conditional expression,
|−0.0012ΔX●ΔZ●(a+b)/N.A.|<TIS_{design}
a: Distance from a center up to an outside edge of a TIS measurement mark used (μm)
b: Distance from the center up to an inside edge of the TIS measurement mark used (μm)
N.A: Image formation N.A. of an object side of the image formation part
ΔX: Amount of overlay misalignment in a step detection direction between the center of the measurement mark and the center of the optical axis, due to manufacturing errors and the like (μm)
ΔZ: Difference of a wavefront aberration Zernike coefficient Z4 at object height 30 μm and the optical axis center (m λ)

Here Z4 is a coefficient applied to a function (2ρ²−1),
TIS_{degisn}: Design specification of an overlay misalignment amount when a measurement mark for which the overlay misalignment amount is zero is measured (nm).

A design method for an image formation optical system in a mark position detection device wherein the image formation optical system is designed so as to satisfy the following conditional expression,
|0.0012≡L●ΔZ●(a+b)/N.A.|<ΔTIS_{design}
a: Distance from a center up to an outside edge of a TIS measurement mark used (μm)
b: Distance from the center up to an inside edge of the TIS measurement mark used (μm)
N.A: Image formation N.A. of an object side of the image formation part
L: Size of field of vision (μm)
ΔZ: Difference of a wavefront aberration Zernike coefficient Z4 at object height 30 μm and the optical axis center (mλ))

Here Z4 is a coefficient applied to a function (2ρ²−1),
ΔTIS_{degisn}: Design specification of a TIS flatness (difference of the largest TIS and the smallest TIS) within a field of vision of a device (nm).

An image formation optical system evaluation method of the present invention includes the steps of: forming an image of a substrate on which a mark was formed, that mark having, at least, two step sets, symmetrically placed with respect to a prescribed axis by the image formation optical system; measuring an amount of misalignment between the center positions of the respective step sets based on this image; and using as indexes, the amount of misalignment between the measured center positions, a true amount of misalignment between the center positions, a distance between the center position of the mark in the field of vision of the image formation optical system and the center of an optical axis of the image formation optical system, and a numerical aperture of the image formation optical system; and thereby evaluating performance of the image formation optical system.

Besides, in the above-stated image formation optical system evaluation method, it is preferable that characteristics of the image formation optical system are evaluated based on a value of ΔZ derived from the following conditional expression, based on measurement value information of the mark measured by the image formation optical system:
ΔZ=|−830●TISₘₑₐₛᵤᵣₑₘₑₙₜ●N.A./[ΔX●(a+b)]|
a: Distance from the center position of step set 1 to the step itself (μm)
b: Distance from the center position of step set 2 to the step (μm)
N.A: Image formation N.A. of an object side of the image formation part
ΔX: Distance in the step detection direction from the optical axis center to the measured mark center (μm)
ΔZ: Absolute value of the difference of a wavefront aberration Zernike coefficient Z4 at object height 30 μm and the optical axis center (mλ)

Here Z4 is a coefficient applied to a function (2ρ²−1),
TISₘₑₐₛᵤᵣₑₘₑₙₜ: Difference between measurement values taken at the center position measured between symmetrical steps and at the center position measured between symmetrical steps other than these (nm).

Besides, in the above-stated image formation optical system evaluation method, it is preferable to further include the steps of: scanning the measurement mark within the field of vision of the image formation optical system; finding at a plurality of positions within the field of vision [a] the distance between the center position of the measurement mark and the center of the optical axis of the image formation optical system and [b] an amount of misalignment between the measured center positions; and evaluating characteristics of the image formation optical system based on measurement value information of the measurement marks within the field of vision of the image formation optical system, based on a value of ΔZ derived from the following relational expression.
ΔZ=|830●ΔTISₘₑₐₛᵤᵣₑₘₑₙₜ●N.A./[L●(a+b)]|
a: Distance from the center position of step set 1 to the step (μm)
b: Distance from the center position of step set 2 to the step (μm)
N.A: Image formation N.A. of the object side of the image formation part
L: Size of field of vision (μm)
ΔZ: Absolute value of the difference of the wavefront aberration Zernike coefficient Z4 at object height 30 μm and the optical axis center (mλ))

Here Z4 is the coefficient applied to the function (2ρ²−1),
ΔTISₘₑₐₛᵤᵣₑₘₑₙₜ: Difference of TIS at both ends of the field of vision found from a function when the TIS fluctuation within the field of vision found by a part that scans a measurement mark within the field of vision was fit to a first-order function (nm).

A mark position detection device of the present invention includes: an image formation optical system that causes the imaging of light reflected from a mark constituted from a plurality of steps formed on a substrate; an image pickup part that fetches an image formed by the image formation optical system; and a detection part detecting positions of the steps based on an output signal from the image pickup part; wherein, the image formation optical system is designed so that, when wavefront aberration of the image formation optical system is expressed by Zernike polynomials, a sum total of aberration terms is kept within a specified value, those terms being ones that act to cause the direction in which the position of the step, detected by the signal processing part, is shifted beyond a true step position, to shift in a direction that varies in response to orientations of the steps.

In a design method for an image formation optical system of a mark position detection device, the device being such that an image is formed by the image formation optical system from light reflected from a mark configured of a plurality of steps formed on a substrate, the image formed by the image formation optical system is fetched to an image pickup part; and positions of the steps are detected based on an output signal from the image pickup part, the image formation optical system is designed to halve a characteristic that, when wavefront aberration of the image formation optical system is expressed by Zernike polynomials, the system selects from among terms of the Zernike polynomials a term that acts to shift in a direction that varies in response to an orientation of the step and a term that acts to shift in a direction that varies in response to the orientation of the step, and further to have a characteristic that the term that acts to shift in a direction that varies in response to the orientation of the step has at least distribution of the aberration which is uniform within the field of vision of the image formation optical system, and the term that acts to shift in a direction that varies in response to the orientation of the step, has at least distribution of the aberration which is straight line distribution within the field of vision of the image formation optical system.

### EFFECT OF THE INVENTION

According to the present invention, it is possible to provide a mark position detection device capable of detecting a mark position with high accuracy. Besides, according to the present invention, it becomes possible to evaluate characteristics of an image formation optical system with high sensitivity.

### BRIEF DESCRIPTION OF THE DRAWINGS

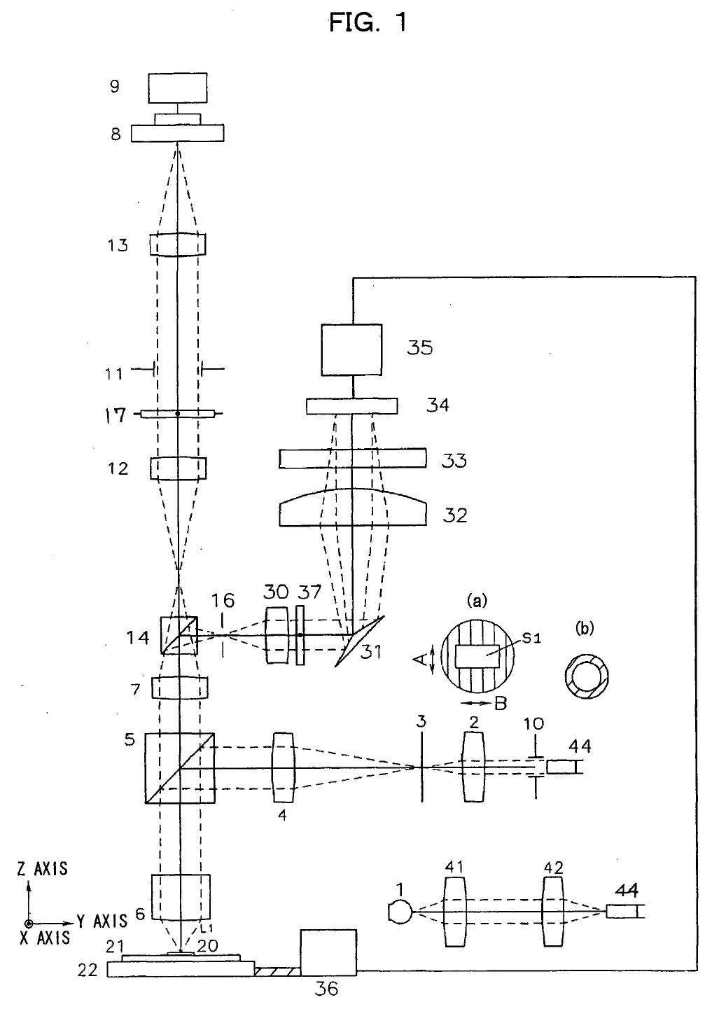

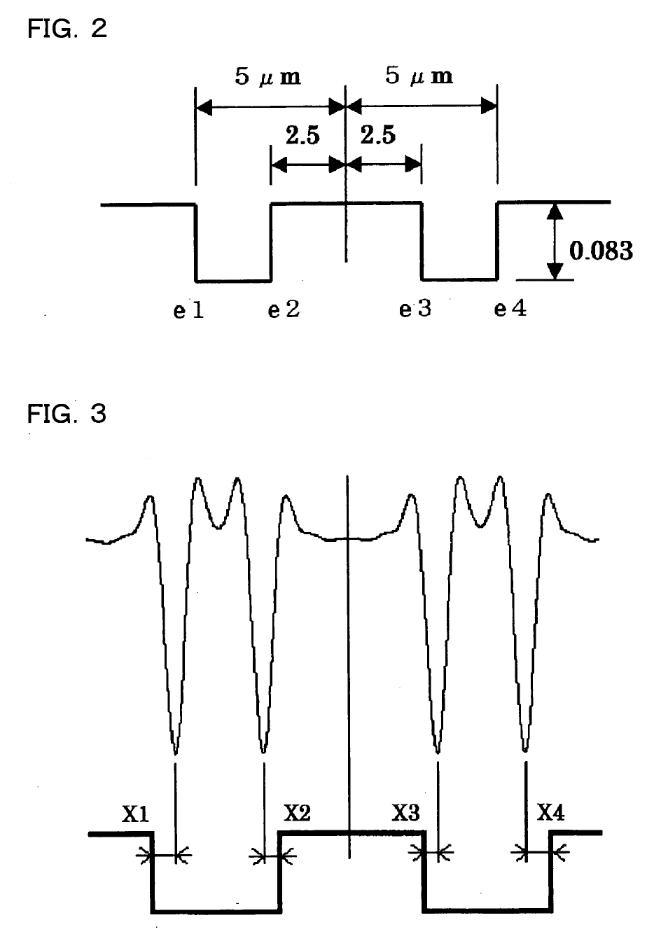

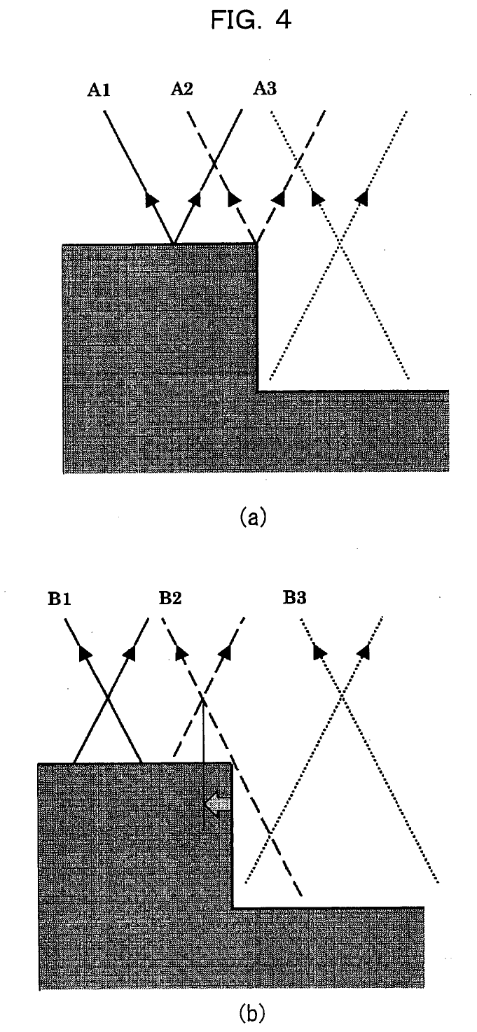

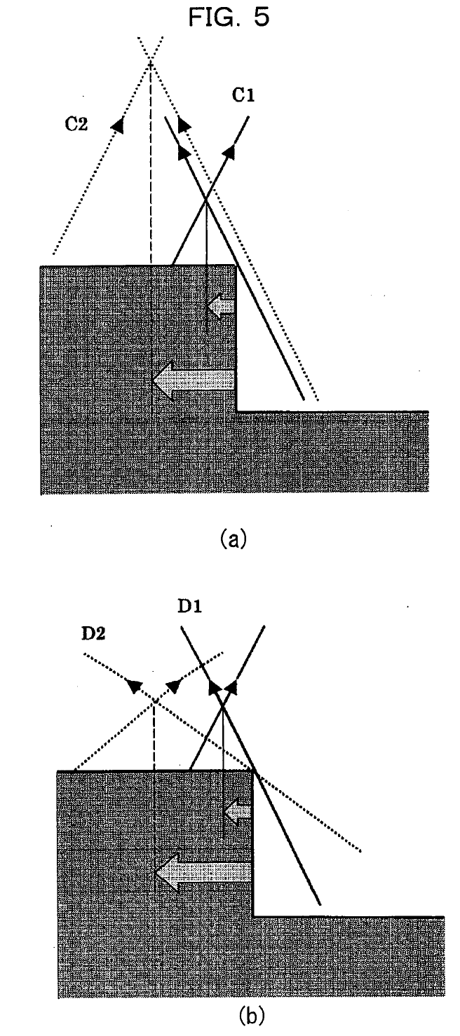

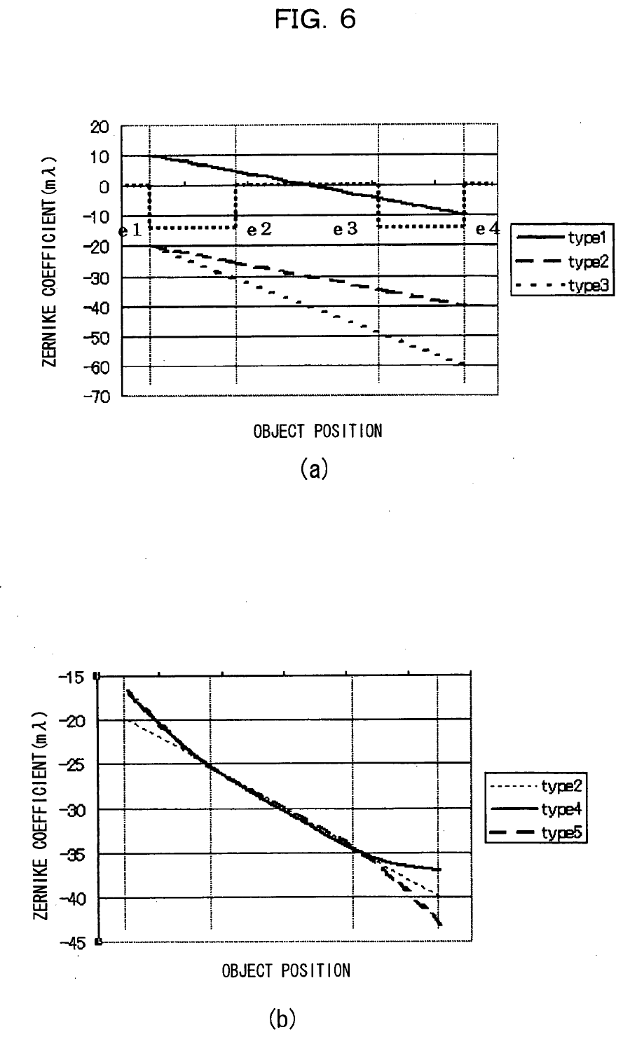

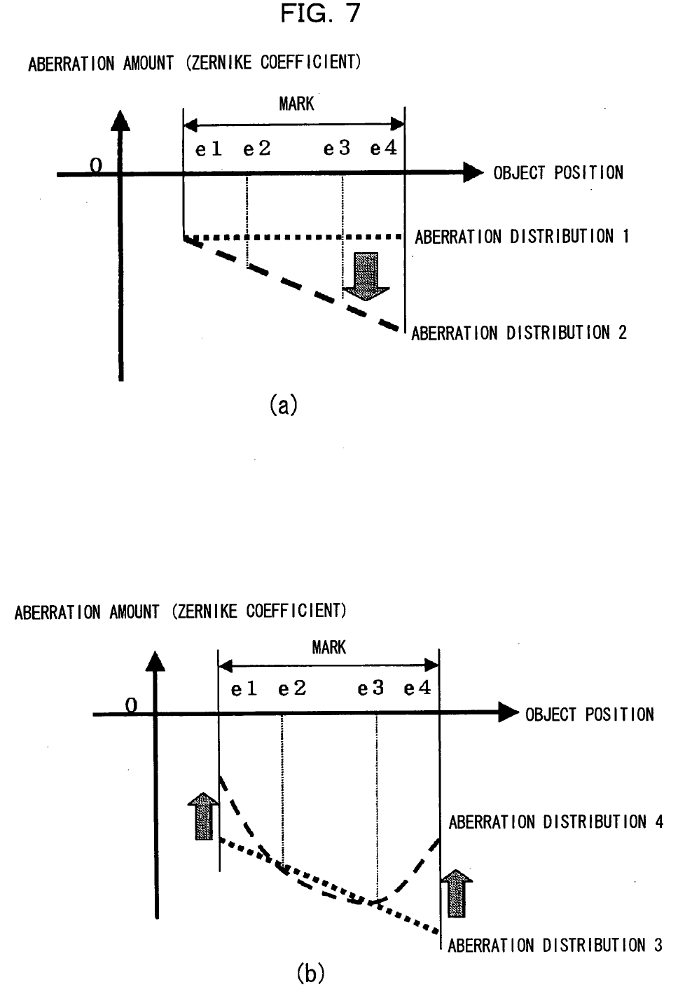

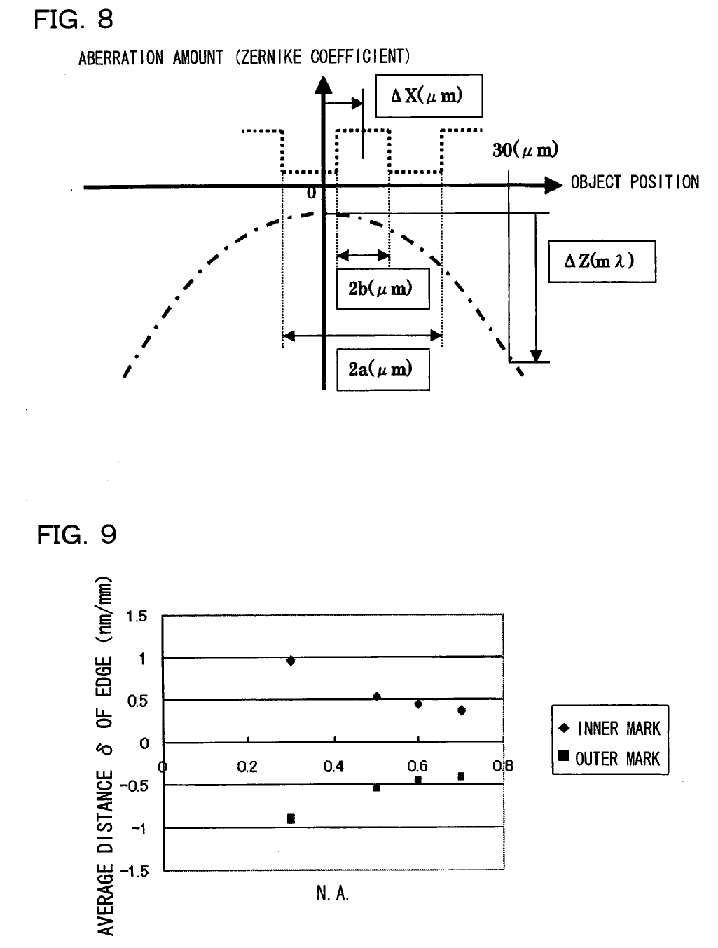

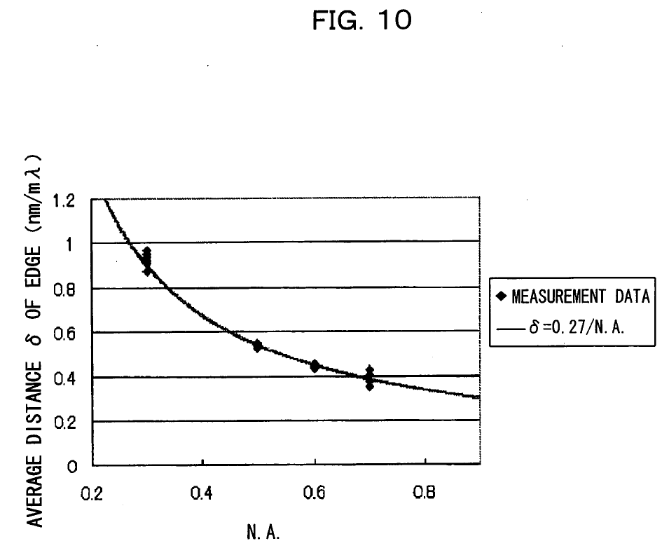

The nature, principle, and utility of the invention will become more apparent from the following detailed description when read in conjunction with the accompanying drawings in which like parts are designated by identical reference numbers, in which:

[FIG. 1] is a constitution chart of an overlay measurement device;

[FIG. 2] is a view showing a measurement mark used in a simulation;

[FIG. 3] is a view showing the mark and intensity distribution obtained from the simulation;

[FIG. 4] are views showing light rays and marks in focus and defocus states;

[FIG. 5] are views showing a relation of a defocus amount, N.A. and a detected misalignment amount of a step position;

[FIG. 6] are views showing aberration distribution used for the simulation;

[FIG. 7] are schematic views of aberration distribution;

[FIG. 8] is a view showing mark positions and the aberration distribution;

[FIG. 9] is a view in which an average misalignment amount of edge per unit aberration is plotted; and

[FIG. 10] is a view showing the above-stated plot and a function which is fitted to the plot.

### BEST MODE FOR CARRYING OUT THE INVENTION

Hereinafter, embodiments of the present invention are described in detail with reference to the drawings.

### First Embodiment

FIG. 1 is an example of an overlay measurement device. Details of optical paths in the present device are as shown in FIG. 1, and an illumination luminous flux with wide-band wavelength emitted from a light source 1 is incident on a light guide fiber 44 via a collector lens 41, a light source relay lens 42. The luminous flux emitted from the light guide fiber 44 is condensed by a condenser lens 2 while a luminous flux diameter thereof is limited by an illumination aperture stop 10, and uniformly illuminates a field stop 3. The field stop 3 has a slit S1 as shown in (a). A shape of the illumination aperture stop 10 is a zone shape as shown in (b). The luminous flux emitted from the field stop 3 is collimated by an illumination relay lens 4, and split by a beam splitter 5. Further, the luminous flux is condensed by an objective lens 6, and illuminates a wafer 21 perpendicularly. Here, the field stop 3 and the wafer 21 are in conjugate positions, and therefore, an image of the slit S1 is image-formed on the wafer 21 via the illumination relay lens 4 and the objective lens 6.

A wafer is carried so that a street pattern existing on the wafer makes an angle of 45 degrees with a longitudinal or short side direction of a field stop. This is to reduce an error of an auto-focus operation influenced by the pattern. A stage is moved such that a measurement mark comes to approximately at a center of a position where the image of S1 is projected. The image of S1 illuminates a mark 20 on the wafer. Here, reflected light from the image of S1 is set to be L1. At this time, the luminous flux L1 reflected from a surface of the wafer 21 is collimated by the objective lens 6, transmits through the beam splitter 5, and condensed again by an imaging lens 7. The luminous flux transmitted through a beam splitter 14 passes through an imaging system plane-parallel plate 17 for aberration correction while a luminous flux diameter is limited by an imaging aperture stop 11, and an image of a wafer mark is image-formed on a surface of an image pickup element CCD 8 by a first relay lens 12 and a second relay lens 13. An output signal from the image pickup element CCD 8 is processed by an image processing part 9, and performs a mark position detection on the wafer, measurement and observation by a television monitor of an overlay amount.

On the other hand, the luminous flux reflected by the beam splitter 14 passes through an AF system field stop 16, collimated by an AF first relay lens 30, and thereafter, passes through a plane-parallel plate 37, and image-forms an image of the illumination aperture stop 10 on a pupil dividing mirror 31. The plane-parallel plate 37 is to make a positional adjustment of an illumination aperture stop image to a center of the pupil dividing mirror, and it is constituted to be tilt adjustable. The luminous flux L1 is divided into two luminous fluxes by the pupil dividing mirror, and condensed again by an AF second relay lens 32. Further, the luminous flux L1 is image-formed relating to a measurement direction into two portions on an AF sensor 34 via a cylindrical lens 33. Besides, the cylindrical lens 33 has a refractive power relating to a non-measurement direction, and the luminous flux of L1 image-forms a light source image on the AF sensor 34. A principle of operation of the auto-focus is described in detail in, for example, Japanese Unexamined Patent Application Publication No. 2002-40322, and therefore, the description is not given in the present embodiment.

Next, summary of a design procedure of a measurement optical system is described. A design of the measurement optical system, constituted by the objective lens 6, the beam splitter 5, the imaging lens 7, the beam splitter 14, the first relay lens 12, the plane-parallel plate 17, the imaging aperture stop 11, and the second relay lens 13 from an object side, is performed by the following procedure. At first, respective surface shape, internal refractive index, and a gap between optical elements of every optical element constituting the measurement optical system, are set, each parameter is reset so that light ray aberration is to be a specified value, and the same procedure is repeated until the light ray aberration falls in a desired range. Next, wavefront aberration of the measurement optical system obtained by the former design is fit to Zernike polynomials of which parameters are a radius of ρ and a radial angle of θ. ρ is normalized as “1” at of the end of an exit pupil. The fitting to the Zernike polynomials is performed also for the light ray of an arbitrary object height in addition to the light ray at an optical axis center. The wavefront aberration of all over the optical system is evaluated from a fluctuation due to the object height of the Zernike polynomials obtained as stated above, the parameters of the respective optical elements are fine adjusted when a fluctuation amount does not falls in a specified value, and the same procedure is repeated until the fluctuation amount falls in the desired range.

Next, an overlay measurement simulation performed by an inventor to derive the present invention is described. An observational mark used is a box in box mark of 10 μm∝ shown in FIG. 2. This mark is constituted by an outer mark of 10 μm∝ composed of two steps e1, e4 in which a step orientation changes from convex to concave toward a mark center, and an inner mark of 5 μm∝ composed of two steps e2, e3 in which the step orientation changes from concave to convex toward the mark center. An imaging simulation is used as a simulation method. Besides, the Zernike polynomials are used as the wavefront aberration. The respective parameters of the simulation are as shown in Table 1.

TABLE 1

| | |
|---|---|
| N.A. | 0.50 |
| Wavelength λ | 0.6563 (μm) |

At first, the wavefront aberrations at respective object positions are obtained as the Zernike polynomials from a design value of the measurement optical system (imaging optical system) of the overlay misalignment, and fluctuation of respective Zernike orders due to the object positions are investigated. This distribution generates an error TIS (Tool Induced Shift) of the overlay misalignment amount, though it will be described later. A mark is disposed at a position of 60 μm from the optical axis of the measurement optical system on the simulation, and the wavefront aberrations corresponding to the respective steps e1, e2, e3, and e4 shown in FIG. 2 are inputted to perform an imaging simulation. Incidentally, the object position is not necessarily to be 60 μm, but here, 60 μm is adopted with considering that the larger the value is, the larger the TIS becomes.

As a result of this simulation, intensive distribution as shown in FIG. 3 is obtained. Bottom positions of signal intensities corresponding to respective step positions are detected to thereby obtain distances of the respective steps resulting from the set aberrations. The TIS can be obtained by using an expression 1 from these values. Incidentally, the distances of edges are represented exaggeratedly in FIG. 3, and actual distances are in orders of “nm”.
TIS=(x2+x3)/2−(x1+x4)/2 (expression 1)

x1: Distance of the step e1

x2: Distance of the step e2

x3: Distance of the step e3

x4: Distance of the step e4

The TIS obtained as stated above does not become “0” (zero), and has some value. Only an arbitrary Zernike order is extracted from the wavefront aberration at each edge position, and the imaging simulation is performed again by inputting the arbitrary Zernike order as a new aberration, so as to ensure the Zernike order which affects the TIS most. The TIS derived from a specific Zernike order obtained from the above and the TIS of a full wavefront aberration are compared, to investigate how far the respective Zernike orders contribute. As a result of this, it turns out that the Zernike order which affects the TIS most is Z4. Z4 is a term representing a defocus, and a defocus difference, namely, a field curvature owing to each image plane affects the TIS. Here, various optical factors are conceivable for the generation of the TIS, but in the present embodiment, it is the case when the mark shape and the parameters are used as stated above, and the case when the wavefront aberrations at the respective object positions are considered as the generation factor of the TIS.

The TIS is generated because the respective step positions are misaligned caused by the aberration and so on. Hereinafter, the case when the respective step positions are misaligned when the Zernike coefficient Z4 (defocus) exists is described by using a hypothesis which is established on a basis of the simulation result. FIGS. 4(a), 4(b) are views in which step portions of the mark are respectively enlarged, and (a) shows a case when the defocus does not exist, and (b) shows a case when an objective lens is defocused in a direction away from the mark. A light ray A1 shows a light ray diffracts at an upper portion of the mark, a light ray A2 shows a light ray diffracts at a step portion, and a light ray A3 shows a light ray diffracts at a mark lower portion of the mark, respectively. A1 to A2 have the same phase states in (a), but the phase changes rapidly in A2. Therefore, a change occurs in an intensity in an imaging calculation, and this position is recognized as an edge.

On the other hand, in (b), a portion of the light ray begins to cross the step at a front side than the step as shown by a light ray B2. Consequently, a change in the phase of the light ray begins to occur, and the change also occurs in the intensity in the imaging calculation. According to the simulation, signal intensity becomes minimum when about two fifth of diffracted light ray gets out of the step portion, and the point is recognized as the edge. Namely, the edge position is observed to be misaligned at the front side of the step.

Appearances of light when a defocus amount is different is shown in FIG. 5(a), and when N.A. is different is shown in (b). An aberration amount of the Zernike coefficient Z4 is larger in a light ray C2 relative to a light ray C1, and the defocus becomes large. Besides, the N.A. of light becomes larger in a light ray D2 relative to a light ray D1. The positions where a portion of the light ray crosses the step shifts toward the more front side (convex side) of the step in both light rays C2, D2, and the step position estimated from the bottom of the intensity is observed to be more misaligned toward the front side (convex side) of the step. It is verified that the misalignment amount of the edge position is approximately in proportion to the defocus amount, and N.A. from the simulation result. In FIG. 5, the step from convex to concave from a left side of the drawing is described, but it can be described similarly as for the step from concave to convex, and when the step shifts from concave to convex, the detected direction in which the step position shifts is in the direction just direct opposite of the direction shown in FIG. 5.

Besides, the detected misalignment direction of the step position becomes opposite between a case when the objective lens is defocused in the direction away from the mark and a case when the objective lens is defocused in the direction coming close to the mark. Namely, when the objective lens is defocused in the direction coming close to the mark, the detected step position is observed to be misaligned toward the concave side of the step.

When all of the step positions of the mark has the same defocus amount, namely, the aberration amounts of the Zernike coefficient Z4 are equal, it becomes to be “x1=−x2=x3=−x4” in the expression 1, then the misalignments of the respective edge positions are offset, and the TIS becomes “0” (zero). However, when the Zernike coefficient Z4 changes at the respective edge positions, the misalignments cannot be offset, and the TIS occurs. This is an occurrence mechanism of the TIS when the field curvature exists.

As stated above, it is described that the Zernike coefficient Z4 affects the TIS measurement in the wavefront aberration obtained from the design value of the measurement optical system.

Next, fluctuation of the wavefront aberration due to the object position is assumed, and a description of an investigated result is performed as for when the TIS is easy to occur in what kind of distribution. In the process of this investigation, it turns out that the respective orders of the Zernike polynomials can be categorized into two types relating to the misalignment direction of the step of the mark detected by the measurement optical system. One type is aberration in which every step is detected to be misaligned in the same direction for approximately the same amount independent of the step orientation, when the aberration amount is uniform on a whole plane of the mark, and Zernike coefficients Z2, Z7, and so on correspond to this type. The other type is aberration in which the detected misalignment directions of the step positions are different depending on the step orientation although absolute values of the misalignment amount of the steps are approximately equal, when the aberration amount is uniform on the whole plane of the mark, and Zernike coefficients Z4, Z5, and so on correspond to this type.

Hereinafter, a result of a simulation performed focusing on Z4, Z7 as representatives of the above-stated two types of aberrations is shown.

Aberration distributions of the respective Zernike orders set in the simulation are shown in FIGS. 6(a), 6(b). In (a), type 1 is aberration distribution in proportion to an object position in which an aberration amount is “0” (zero) at a center of a mark, and a difference between both edges becomes 20 mλ, type 2 is aberration distribution having the same inclination with the type 1, in which the aberration amount is −30 mλ at the center of the mark, and Type 3 is aberration distribution having double inclination of the type 1, in which the aberration amount is −20 mλ at a left outside edge position which is the same value as the type 2, and the difference between both edges becomes to be 40 mλ. Besides, in (b), type 4 is curved aberration distribution in which the aberration amount is changed for 3 mλ toward a plus side at both outside edge positions of the type 2, and type 5 is aberration distribution which is point symmetry with respect to the center in which the left outside edge position of the type 2 is changed for +3 mλ, and a right outside edge position is changed for −3 mλ.

Distances x1 to x4 of the respective steps e1, e2, e3, and e4, average distances of an inside step and outside step, and TIS detected in a measurement optical system in which the Zernike coefficient Z4 becomes the above-stated aberration distribution is shown in Table 2, and those detected in the measurement optical system in which Z7 becomes the above-stated aberration distribution are shown in Table 3, all together.

TABLE 2

| | | | | | Inside step | Outside step | |
|---|---|---|---|---|---|---|---|
| Aberration: | x1 | x2 | x3 | x4 | Average distance | Average distance | TIS |
| Z4 | (nm) | (nm) | (nm) | (nm) | (nm) | (nm) | (nm) |
| Type 1 | 12.8 | −7.4 | −3.5 | 8.9 | −5.5 | 10.9 | −16.4 |
| Type 2 | −19.8 | 25.3 | −36.1 | 41.7 | −5.4 | 11.0 | −16.4 |
| Type 3 | −19.8 | 30.8 | −52.3 | 63.4 | −10.8 | 21.8 | −32.6 |
| Type 4 | −16.5 | 25.3 | −36.1 | 38.4 | −5.4 | 11.0 | −16.4 |
| Type 5 | −16.5 | 25.3 | −36.1 | 44.9 | −5.4 | 14.2 | −19.6 |

TABLE 3

| | | | | | Inside step | Outside step | |
|---|---|---|---|---|---|---|---|
| Aberration: | x1 | x2 | x3 | x4 | Average distance | Average distance | TIS |
| Z7 | (nm) | (nm) | (nm) | (nm) | (nm) | (nm) | (nm) |
| Type 1 | 9.9 | 2.0 | −2.0 | −9.9 | 0.0 | 0.0 | 0.0 |
| Type 2 | −13.8 | −21.8 | −26.0 | −33.6 | −23.9 | −23.7 | −0.2 |
| Type 3 | −13.8 | −25.7 | −38.1 | −49.5 | −31.9 | −31.7 | −0.2 |
| Type 4 | −11.4 | −21.8 | −26.0 | −31.2 | −23.9 | −21.3 | −2.6 |
| Type 5 | −11.4 | −21.8 | −26.0 | −36.0 | −23.9 | −23.7 | −0.2 |

The following things can be seen from the above results.
1. The respective step positions are observed with a slight misalignment even when the aberration does not exist, and they become “x1=2, x2=−2, x3=2, and x4=−2 nm”. This is because of an interference from an adjacent steps. If this misalignment amount in an initial state is considered, an approximately proportional relationship can be seen between the aberration amount and the detected misalignment amount of the step positions. Namely, they becomes to be an expression 2, when they become “x1′=x1−2, x2′=x2+2, x3′=x3−2, x4′=x4+2”.
   x1′x2′x3′x4′∝ (aberration amount at the respective step positions) (expression 2)
2. In the aberration of the type represented by the Zernike coefficient Z4, in which the detected shift directions of the steps are reversed depending on the orientations of the steps, the larger the aberration fluctuation at the object position is, the larger the TIS becomes. The approximately proportional relationship can be seen between the fluctuation amount and the TIS.
3. In the aberration of the type represented by the Zernike coefficient Z7, in which the detected shift directions of the steps are the same independent of the orientations of the steps, the TIS is seldom generated if the aberration fluctuation at the object position is linearly. Besides, the TIS is seldom generated in the aberration distribution which is point symmetry with respect to the mark center even though the aberration is out of the straight line distribution. Namely, the more the aberration is out of the distribution which is point symmetry with respect to the mark center, the more the TIS is generated.

Hereinafter, the above-stated fact is described by using the expression 1. At first, it is assumed that an original aberration distribution is to be aberration distribution 1 in FIG. 7(a) as for the aberration of the type in which the detected shift directions of the steps are reversed depending on the orientations of the steps. At this time, the distances of the respective steps become “x1=−a, x2=a, x3=−a, x4=a (a>0)”, and they can be represented by the following expression by using the expression 1.
TIS1=(a−a)/2−(−a+a)/2=0

When the change from this distribution 1 to distribution 2 is considered, every absolute value of the aberration at the edge positions e2, e3, and e4 of the mark becomes to be an increasing direction. The larger the aberration is, the larger the distance becomes, and therefore, the distances of the respective edges become “x1=−a, x2=a+b, x3 32 −a−c, and x4=a+d (a>0, d>c>b>0)”, and they can be represented by the following expression by using the expression 1.
TIS2=[(a+b)+(−a−c)]/2−[a+(a+d)]/2=(b−c)/2−d/2

It can be seen from “(b−c)/2<0 (inside step average), d/2>0 (outside step average)”, that signs of the distance become opposite between the inside step average and outside step average, and the larger TIS is generated. It is necessary that both “(b−c)” and “d” are to be approximated to “0” (zero) and that both aberration fluctuations between inside edges and between outside edges are made to be small, to suppress the TIS to small in the aberration type as stated above. Namely, it is required that the aberration is to be flat for all over the mark.

Next, it is assumed that an original aberration distribution is distribution 3 in FIG. 7(b) as for the aberration of the type in which the detected shift directions of the steps are the same independent of the orientations of the steps. At this time, the distances of the respective steps are “x1=−a, x2=−b, x3=−c, x4=−d (a, b, c, d>0)”, then they can be represented by the following expression by using the expression 1.
TIS3=(−b−c)/2−(−a−d)/2=[(−b+2)+(−c−2)]/2−[(−a−2)+(−d+2)]/2

When the misalignment amount without aberration is taken into consideration, there is the approximately proportional relationship between the misalignment amount of the respective steps and the aberration amount, and therefore, they can respectively be expressed by using the expression 2 as follows: “(−a−2)∝ (aberration amount at e1), (−b+2) ∝ (aberration amount at e2), (−c−2)∝ (aberration amount at e3), (−d+2)∝ (aberration amount at e4). Consequently, when it is taken into consideration that the aberration distribution is a straight line relative to the object position, it becomes to be the following expression, and it turns out that the TIS is seldom generated in the straight line distribution.

$$\begin{matrix}TIS 3 ∝ [ ( aberration amount at e 2 + ( aberration amount at e 3 ] / 2 - \\ [ ( aberration amount at e 1 ) + ( aberration amount at e 4 ) ] / 2 \\ = ( aberration amount at mark center ) - ( aberration amount \\ at mark center ) \\ = 0 ( zero )\end{matrix}$$

The change from the distribution 3 to distribution 4 is considered. In FIG. 7(b), the absolute values of the aberration show decreasing directions both at the step positions e1 and e4 of the mark, but it may show increasing directions. The detected distances of the respective steps can be expressed as “x1=−a+e, x2=−b, x3=−c, x4=−d+f(a, b, c, d>0, e, f; >0 (at the time of change in the drawing), <0 (at the time of change in the opposite direction to the drawing))”, and they becomes to be the following expression by using the expression 1, and the TIS is generated.

$$\begin{matrix}TIS 4 = ( - b - c ) / 2 - [ ( - a + e ) + ( - d + f ) ] / 2 \\ = ( - b - c ) / 2 - ( - a - d ) / 2 - ( e + f ) / 2 \\ = TIS 3 - ( e + f ) / 2 = - ( e + f ) / 2\end{matrix}$$

It is necessary that “e” and “f” have opposite signs, namely, ways how to be out of the straight line distribution of the aberration are to be opposite directions to suppress the TIS into small in the aberration type as stated above. Namely, it is required that the aberration distribution is near to be point symmetry with respect to the mark center.

The following things are required to suppress the TIS into small when the above is summarized.
1. In the aberration of the type represented by the Zernike coefficient Z4, in which a detected shift directions of the steps are reversed depending on the orientations of the steps, the aberration must be flat as much as possible for all over the mark area. Besides, a result has been obtained in this type of aberration, in which Z4 (defocus) generates the TIS most and next to Z4, Z5 (astigmatism) generates the TIS of approximately 50 percent of the above when the aberration distribution is the same, although it is not shown in the table. 2. In the aberration of the type represented by the Zernike coefficient Z7, in which the detected shift directions of the steps are the same independent of the orientations of the steps, the aberration distribution must be close to point symmetry with respect to the mark center. However, in actual, it is difficult to control the aberration distribution to be point symmetry, and therefore, a design, manufacturing, and adjustment are performed so as not to generate undulations in the aberration distribution. Besides, a result has been obtained in this type of aberration, in which Z2 (lateral misalignment) generates the TIS most, and next to Z2, Z7 (coma) generates the TIS of approximately 60 percent of the above when the aberration distribution is the same.

In consideration of the above-stated results, a condition is observed in which the TIS is generated when the “box in box mark” is used in an actual measurement device.

According to the simulation, a straight line component of the aberration having a difference of approximately 3 (mλ) at both ends of the mark is required in Z4 to generate the TIS for 2.5 (nm). On the other hand, an undulation component in which a misalignment from the straight line distribution is to be 3 (mλ) is required in Z7. When the distribution of the wavefront aberration is obtained from the design value of the measurement optical system, the straight line component is approximately more dominative than the undulation component in the aberration distribution according to a mark scale, though tendencies such as small and large of values in each order of the Zernike, an undulating way of distribution are different. In fact, the TIS is generated approximately only by Z4 in the simulation using the wavefront aberration of the design value as stated above. Incidentally, in the simulation, the TIS becomes “0” (zero) when the mark is disposed on an optical axis. This is because the Zernike component Z4 has symmetry with respect to the optical axis, and because the aberration amounts become equal respectively between the inside step positions and between the outside step positions with each other even when the distribution of the aberration is not completely flat. However, in an actual device, at least, an influence to the TIS by an aberration component of Z4 surely exists because there is a possibility that it is measured at a position misaligned from a desired center of a filed of vision resulting from a manufacturing error and so on. Besides, as stated above, it is conceivable that a percentage of a contribution from Z4 is not small, if it is taken into consideration that the influence of the undulation component of the aberration for the TIS is not so dominative.

Accordingly, the amount of TIS generated when a misalignment occurs in a visual field position in certain distribution of the Zernike coefficient Z4 is obtained by a simulation. Degrees of the aberration amount of Z4 and the misalignment amount of the visual field position to be suppressed to, can be seen from a result of the simulation, when a design is made to attain a certain specification of TIS.

Hereinafter, results of investigation are described. A distribution of the Zernike coefficient Z4 and a condition in which a mark is disposed misaligned from a center are shown in FIG. 8. It is known that the distribution of Z4 can be fitted by a second-order function well from the investigation of the design value, and therefore, it is set as the quadratic function distribution also in the present simulation. Besides, a value of a difference ΔZ (mλ) between the aberration amount of Z4 at the center of the optical axis center, and the aberration amount of Z4 at a position misaligned for 30 μm in a detection direction of the step from the optical axis is adopted as an index representing the distribution of Z4. Incidentally, here, the difference of Z4 between at the optical axis center position and at the position misaligned for 30 μm in the detection direction of the step from the optical axis center is set as the index of the distribution of Z4, but a similar argument is also possible at an arbitrary object position, and it goes without saying that the function fitted to the distribution of Z4 can be used as the index.

The mark to be measured is a “box in box” mark in which a distance between outside steps is 2a (μm), a distance between inside steps is 2b (μm), and a misalignment amount in a measurement direction of the step between the optical axis center position and the corresponding mark center position is set as ΔX (μm). Differences Δz (outside), Δz (inside) of aberration amounts between the outside steps with each other, and between the inside steps with each other become to be the following expressions.

$$\begin{matrix}Δ z ( outside ) = [ - Δ Z \times {[ ( a + Δ X ) / 30 ]}^{2} ] - [ - Δ Z \times \\ {[ ( - a + Δ X ) / 30 ]}^{2} ] = - 4 Δ X \cdot Δ Z \cdot a / 900 ( m λ ) \\ Δ z ( inside ) = [ - Δ Z \times {[ ( b + Δ X ) / 30 ]}^{2} ] - [ - Δ Z \times \\ {[ ( - b + Δ X ) / 30 ]}^{2} ] = - 4 Δ X \cdot Δ Z \cdot b / 900 ( m λ )\end{matrix}$$

According to the simulation, the following relationship (described later) exists between an average misalignment amount of the step position and a numerical aperture of the measurement optical system per unit aberration amount.

Between outside steps: −0.27/N.A. (nm/mλ)

Between inside steps: 0.27/N.A. (nm/mλ)

Consequently, it becomes to be an expression 3.

$$\begin{matrix}TIS = ( - 4 Δ X \cdot Δ Z \cdot b / 900 \times 0.27 / N . A . ) - \\ [ - 4 Δ X \cdot Δ Z \cdot a / 900 \times ( - 0.27 / N . A . ) ] \\ = - 0.0012 Δ X \cdot Δ Z \cdot ( a + b ) / N . A . ( nm )\end{matrix} \qquad ( expression 3 )$$

It is necessary that at least the TIS caused by Z4 obtained here falls within a designed specification so as to satisfy a design specification TIS_{design} of the TIS in a device, and therefore, ΔZ has to satisfy the following conditional expression.
|−-0.0012 ΔX●ΔZ●(a+b)/N.A.I<TIS_{design} (nm) (expression 4)

As an example, a calculation is performed assuming a case of N.A.=0.5, and a normally used “box in box” mark with an outer edge width of 30 (μm), an inner edge width of 15 (μm). Then, it becomes |−0.054ΔX●ΔZ|<TIS_{design} (nm), and it becomes |ΔX●ΔZ|<56 (μm●mλ) when the design specification of the TIS is 3 (nm). When there is a possibility that the mark position is misaligned for 25 μm from the optical axis, the fluctuation of the Zernike coefficient Z4 at the position away from the optical axis for 30 (μm) must be less than 2 (mλ).

It turns out from the simulation that the following relationship exists in the difference between an detected average misalignment amount Xave of the step position per unit aberration amount and the aberration amount, by using N.A..
Xave (outside)=−0.27/N.A.(nm/mλ)
Xave (inside)=0.27/N.A.(nm/mλ)

Hereinafter, these are described.

The used aberration is the Zernike coefficient Z4. Simulations are performed by using these aberration types having straight line distributions in which this distribution of Z4 is linearly and differences between an aberration value at one end of the mark and an aberration value at the other end become to be 5 mλ, 20 mλ, and 40 mλ. The mark shape shown in FIG. 2 is used. The simulations are performed for the respective aberration types with conditions of N.A.: 0.3, 0.5, 0.6, 0.7, and average distances of the inside step position and outside step position are obtained. FIG. 9 is a view in which the above-stated values are divided by the differences of the aberration amounts at the respective step positions. A horizontal axis represents N.A., and a vertical axis represents an average distance δ of an edge per unit aberration. As a result that this data is fitted by using a function of “δ=a×(N.A.)^{b}”, approximately close values can be obtained for both inner mark and outer mark, and therefore, these values are averaged, to obtain “a=0.27, b=−1.0”. Incidentally, signs are reversed between the inner mark and the outer mark in the data of FIG. 9, when a mark in which ups and downs of the mark shown in FIG. 2 are reversed is used, namely, in case of a mark in which the outside step shifts from concave to convex toward the center of the mark, and the inside step shifts from convex to concave.

FIG. 10 is a view in which measurement data composed of the outside step data of which signs are reversed and the inside step data, and the above-stated function are plotted. It is shown that this result is in reverse proportion to N.A. Hereinafter, the above is examined.

The Zernike coefficient Z4 is represented by “2ρ²−1” (“ρ” is approximately equivalent to N.A.), and “ρ” is normalized at the maximum N.A.. Namely, when the aberration amount is 5 mλ, a misalignment amount from an ideal wavefront is to be 5 mλ at N.A. of 0.5, and the misalignment amount from the ideal wavefront is to be 5 mλ at N.A. of 0.7. The larger, N.A. is, the larger “ρ” becomes, and therefore, an effect for the defocus is larger at 5 mλ in N.A. of 0.5 than at 5 mλ in N.A. of 0.7 when it is seen from a certain N.A.. Concretely speaking, a term of “ρ²” works, and the defocus amount is in proportion to “1/N.A. ²” when the Zernike coefficient Z4 are equal amounts.

Besides, the misalignment amount of the edge is in proportion to both the defocus amount and N.A. as it is already described by using FIGS. 5a, 5b. Consequently, when the aberration amounts of the Zernike coefficient Z4 are equal, the following relationship comes into effect.

(Defocus amount)∝1/N.A.²

(Detected misalignment amount of step position)∝(Defocus amount)×N.A.

Accordingly, the following relationship comes into effect, and the result is in reverse proportion to the first power of N.A..

(Detected misalignment amount of step position)∝1 N.A.²×N.A.=1/N.A.

### Second Embodiment

In the above-stated first embodiment, the value to which Z4 is to be suppressed in accordance with the specification value of TIS of a device is derived from the aberration amount at a specified image height of the measurement optical system. However, in the present embodiment, an acceptable fluctuation amount of the Zernike coefficient Z4 to be satisfied is derived from a specification of a TIS flatness (difference between the maximum value and the minimum value of TIS) within a field of vision by using a relationship of the above-stated expression 3. Hereinafter, it is described.

There are various sizes of marks used at an overlay measurement device, and it is desirable that the TIS is to be small as much as possible if these marks are measured at any position within the field of vision. Accordingly, measurements of the TIS are sequentially performed while moving the mark as shown in FIG. 2 within the field of vision of the measurement optical system, change characteristics of the TIS are examined within the visual field area, and an adjustment to move a position where the TIS is in good state toward a center of a field of vision is performed by using the characteristic as an approach. Accordingly, it becomes possible to approximate the aberration to the distribution which is approximately symmetric with respect to a center of the field of vision within the field of vision. However, the aberration does not completely become flat, and an inclined component remains without fail. This inclined component can be improved for some extent by an optical adjustment, but there is a limit for the improvement by the adjustment, and it is impossible to make the value smaller than a certain value or less. A main cause thereof is the Zernike coefficient Z4. A criteria compatible with a specification of a device is provided for the flatness of the TIS, and as shown in the first embodiment, it is possible to derive how degree the fluctuation amount of the Zernike coefficient Z4 is to be suppressed or less from the criteria by using the expression 3 in a design of the device.

Now, in the expression 3, a relation between ΔX and TIS is represented as follows, while other values than the distance AX between the optical axis center and the mark center and the TIS are set as constants.
TIS=(−0.0012●ΔZ●(a+b)/N.A.)●ΔX (expression 5)

This expression represents the TIS value when the mark is moved within the visual field position, namely, change characteristics of the TIS. It can be seen from this expression that the change amount becomes a first-order function, and the largest TIS differences appear at both edges of the field of vision. Therefore, the flatness of the TIS ΔTIS (nm) is represented by an expression 6 when a visual field size is set as L (μm)

$$\begin{matrix}Δ TIS = \vert ( - 0.0012 \cdot Δ Z \cdot ( a + b ) / N . A . ) \cdot ( - L / 2 ) - \\ ( - 0.0012 \cdot Δ Z \cdot ( a + b ) / N . A . ) \cdot ( L / 2 ) \vert \\ = \vert 0.0012 \cdot L \cdot Δ Z \cdot ( a + b ) / N . A . \vert ( nm )\end{matrix} \qquad ( expression 6 )$$

It is necessary that ΔTIS obtained here at least falls within a design specification, to satisfy a design specification ΔTIS_{design} of the TIS flatness, and therefore, ΔZ must satisfy the following conditional expression.
|0.0012●L●ΔZ●(a+b)/N.A.|<ΔTIS_{design} (nm) (expression 7)

For example, when “N.A.=” is set as 0.5; a mark to be measured is a mark having a shape as shown in FIG. 2, and a distance between outside steps is 10 μm, a distance between inside steps is 5 μm; and a visual field size is set as 50 μm, it becomes to be “|0.9 ΔZ|<ΔTIS_{design} (nm)”. In this case, when the specification of the TIS flatness within the field of vision is set as 2 nm, the fluctuation of the Zernike coefficient Z4 at the position away from the optical axis for 30 μm must be less than 2 mλ.

### Third Embodiment

Besides, in an actual device, it is assumed that a measurement mark is disposed at an arbitrary visual field position, and a TIS measurement value TISₘₑₐₛᵤᵣₑₘₑₙₜ is obtained. This TISₘₑₐₛᵤᵣₑₘₑₙₜ is generated by various factors, but the amount of Z4 can be represented as follows by modifying the expression 3, when the above-stated factor is mainly Z4.
|ΔZ|=|−830●TISₘₑₐₛᵤᵣₑₘₑₙₜ●N.A./[ΔX●(a+b)]|(mλ) (expression 8)

It is possible to estimate a fluctuation of the Zernike coefficient Z4 due to an object position which is difficult to measure directly, and to evaluate characteristics of an optical system from the above expression. The expression 8 is for a case when the factor of TIS is mainly Z4, and it can be used especially effectively when all over the mark deviates from the optical axis center, namely, when “ΔX>a”.

### Fourth Embodiment

A method is effective examining a fluctuation of TIS within a field of vision by scanning a small measurement mark within a visual field position so as to perform the above-stated evaluation method more reliably. Hereinafter, this method is described.

The small measurement mark is scanned within the field of vision to sequentially measure the TIS, and the fluctuation of the TIS within the field of vision is obtained. A cause of this fluctuation is mainly Z4. Next, this fluctuation is fitted by a first-order function, and a difference of the TISs at both field of vision edges obtained from this function is set as ΔTISₘₑₐₛᵤᵣₑₘₑₙₜ, then it becomes the following expression by modifying the expression 6.
|ΔZ|=|830●ΔTISₘₑₐₛᵤᵣₑₘₑₙₜ●N.A./[L●(a+b)]|(mλ) (expression 9)

It becomes possible to estimate a fluctuation of the Zernike coefficient Z4 due to an object position which is difficult to measure directly, and to evaluate characteristics of an optical system, by using this expression.

### Fifth Embodiment

In the above-stated second embodiment to fourth embodiment, the description is performed focusing on Z4 among the Zernike polynomials. However, it goes without saying that all of aberration terms in which detected misalignment directions of step positions are different depending on the orientations of the steps among the aberration terms of the Zernike polynomials are applicable in these descriptions. As an index at a time of design, all of the aberration terms showing the above-stated characteristic may be used as the index, or some of the terms having a large influence on the misalignment amount of the TIS may be selected to be used as the index.

As it is described in the first embodiment, the TIS of the measurement optical system can further be suppressed to a small value by constituting such that the aberration distribution becomes straight line distribution from a design stage, further as for the aberration terms in which the detected misalignment direction of the step position is independent of the step orientation.

Besides, in the present embodiment, the description is performed by taking the “box in box” mark as an example, but the mark to be used is not limited to this. A shape thereof is not limited as long as the mark is constituted by at least two pairs of steps disposed at least symmetrically, such as plural convex lines and concave lines, a combination these, or a combination of a line mark and a box mark. However, it is preferable that a mark in which the TIS amount generated by the aberration is large, namely, having a high sensitivity for the aberration is used, when an optical system is designed, or an evaluation of the optical system is performed.

What is claimed is:

1. A mark position detection device comprising:
an image formation optical system that causes the imaging of light reflected from a mark constituted of a plurality of steps formed on a substrate;
An image pick up part that fetches an image formed by said image formation optical system; and
a detection part that detects positions of said steps based on an output signal from said image pickup part wherein, when wavefront aberration of said image formation optical system is expressed by Zernike polynomials, an amount of change due to an object height of Z4 among said polynomials amounts to a prescribed range according to a position detection precision of said mark position detection device.

2. The mark position detection device according to claim 1, wherein the optical system of an image formation part satisfies the following conditional expression,

|−0.0012 ΔX●ΔZ●(a+b)/N.A.|<TIS_{design}
where:
a: Distance from a center up to an outside edge of a TIS measurement mark used (μm);
b: Distance from the center up to an inside edge of the TIS measurement mark used (μm);
N.A: Image formation N.A. of an object side of the image formation part;
ΔX: Amount of overlay misalignment in a step detection direction between the center of a measurement mark and a center of an optical axis, due to manufacturing errors and the like (μm);
ΔZ: Difference of the wavefront aberration Zernike coefficient Z4 at object height 30 μm and the optical axis center (mλ);
Here Z4 is a coefficient applied to a function (2ρ²−1),
ΔTIS_{degisn}: Design specification of the overlay misalignment amount when a measurement mark for which the overlay misalignment amount is zero is measured (nm).

3. The mark position detection device according to claim 1 wherein the optical system of said image formation part satisfies the following conditional expression:

|0.0012●L●ΔZ●(a+b)/N.A.|<ΔTIS_{design}
a: Distance from the center up to the outside edge of the TIS measurement mark used (μm);
b: Distance from the center up to the inside edge of the TIS measurement mark used (μm);
N.A: Image formation N.A. of the object side of the image formation part;
L: Size of field of vision (μm);
ΔZ: Difference of the wavefront aberration Zernike coefficient Z4 at object height 30 μm and the optical axis center (m λ);
Here Z4 is the coefficient applied to the function (2ρ²−1),
ΔTIS_{degisn}: Design specification of a TIS flatness (difference of the largest TIS and the smallest TIS) within the field of vision of the device (nm).

4. A design method for an image formation optical system in a mark position detection device wherein said image formation optical system is designed so as to satisfy the following conditional expression,

|−0.0012ΔX●ΔZ●(a+b)/N.A.|<TIS_{design}
a: Distance from a center up to an outside edge of a TIS measurement mark used (μm);
b: Distance from the center up to an inside edge of the TIS measurement mark used (μm);
N.A: Image formation N.A. of an object side of an image formation part;
ΔX: Amount of misalignment in a step detection direction between the center of the measurement mark and a center of an optical axis due to manufacturing errors and the like (μm);
ΔZ: Difference of a wavefront aberration Zernike coefficient Z4 at object height 30 μm and the optical axis center (m λ);
Here Z4 is a coefficient applied to a function (2ρ²−1),
TIS_{degisn}: Design specification of an overlay misalignment amount when a measurement mark for which the overlay misalignment amount is zero is measured (nm).

5. A design method for an image formation optical system in a mark position detection device wherein said image formation optical system is designed so as to satisfy the following conditional expression,

|0.0012●L●ΔZ●(a+b)/N.A.I<ΔTIS_{design}
a: Distance from a center up to an outside edge of a TIS measurement mark used (μm);
b: Distance from the center up to an inside edge of the TIS measurement mark used (μm);
N.A: Image formation N.A. of an object side of the image formation part;
L: Size of field of vision (μm);
ΔZ: Difference of a wavefront aberration Zernike coefficient Z4 at object height 30 μm and the optical axis center (m λ);
Here Z4 is a coefficient applied to a function (2ρ²−1),
ΔTIS_{degisn}: Design specification of a TIS flatness (difference of the largest TIS and the smallest TIS) within the field of vision of the device (nm).

6. An image formation optical system evaluation method comprising the steps of:
forming an image of a substrate on which a mark was formed, that mark having, at least, two step sets, symmetrically placed with respect to a prescribed axis depending on said image formation optical system;
measuring an amount of misalignment between center positions of said respective step sets based on this image; and
using as indexes, the amount of misalignment between said measured center positions, a true amount of misalignment between said center positions, a distance between the center position of the mark in a field of vision of said image formation optical system and a center of an optical axis of said image formation optical system, and a numerical aperture of said image formation optical system; and
thereby evaluating performance of said image formation optical system.

7. The image formation optical system evaluation method according to claim 6 wherein, based on measurement value information of the mark measured by said image formation optical system, characteristics of said image formation optical system are evaluated based on a value of ΔZ derived from the following conditional expression:
ΔZ=|−830●TISₘₑₐₛᵤᵣₑₘₑₙₜ●N.A./[ΔX●(a+b)]|

a: Distance from the center position of step set 1 to a step itself (μm);
b: Distance from the center position of step set 2 to the step (μm);
N.A: Image formation N.A. of an object side of the image formation part;
ΔX: Distance in a step detection direction from the optical axis center to the measured mark center (μm);
ΔZ: Absolute value of a difference of a wavefront aberration Zernike coefficient Z4 at object height 30 μm and the optical axis center (m λ);
Here Z4 is a coefficient applied to a function (2ρ²−1),
TISₘₑₐₛᵤᵣₑₘₑₙₜ: Difference between measurement values taken at the center position measured between symmetrical steps and at the center position measured between symmetrical steps other than these (nm).

8. The image formation optical system evaluation method according to claim 6 further comprising the steps of:
scanning the measurement mark within the field of vision of said image formation optical system;
finding at a plurality of positions within said field of vision [a] the distance between the center position of said measurement mark and the center of the optical axis of said image formation optical system and [b] the amount of misalignment between said measured center positions; and
evaluating characteristics of said image formation optical system based on the measurement value information of the measurement marks within the field of vision of said image formation optical system, based on a value of ΔZ derived from the following relational expression,
ΔZ=|830●ΔTISₘₑₐₛᵤᵣₑₘₑₙₜ●N.A./[L●(a+b)]|

a: Distance from the center position of step set 1 to a step itself (μm);
b: Distance from the center position of step set 2 to the step (μm);
N.A: Image formation N.A. of the object side of the image formation part;
L: Size of field of vision (μm);
ΔZ: Absolute value of the difference of the wavefront aberration Zernike coefficient Z4 at object height 30 μm and the optical axis center (m λ);
Here Z4 is the coefficient applied to the function (2ρ²−1),
ΔTISₘₑₐₛᵤᵣₑₘₑₙₜ: Difference of TIS at both ends of the field of vision found from a function when a TIS fluctuation within the field of vision found by a part that scans a measurement mark within the field of vision was fit to a first-order function (nm).

9. A mark position detection device comprising:
an image formation optical system that causes the imaging of light reflected from a mark constituted from a plurality of steps formed on a substrate;
an image pickup part that fetches an image formed by said image formation optical system; and
a detection part detecting positions of said steps based on an output signal from said image pickup part;
wherein, said image formation optical system is designed so that, when wavefront aberration of said image formation optical system is expressed by Zernike polynomials, a sum total of aberration terms is kept within a specified value, those terms being ones that act to cause a direction in which the position of said step, detected by a signal processing part, is shifted beyond a true said step position, to shift in the direction that varies in response to orientations of said steps.

10. A design method for an image formation optical system for a mark position detection device, said device being such that an image is formed by the image formation optical system from light reflected from a mark configured of a plurality of steps formed on a substrate, the image formed by said image formation optical system is fetched to an image pickup part, and positions of said steps are detected based on an output signal from said image pickup part;
said image formation optical system being designed to have a characteristic that, when wavefront aberration of said image formation optical system is expressed by Zernike polynomials, the system selects from among terms of said Zernike polynomials a term that acts to shift in a direction that varies in response to an orientation of said step and a term that acts to shift in direction that varies in response to the orientation of said step, and further to have a characteristic that the term that acts to shift in the direction that varies in response to the orientation of said step has at least distribution of said aberration which is uniform within a field of vision of said image formation optical system, and the term that acts to shift in the direction that varies in response to the orientation of said step, has at least the distribution of said aberration which is a straight line distribution within the field of vision of said image formation optical system.
The invention is not limited to the above embodiments and various modifications may be made without departing from the spirit and scope of the invention. Any improvements may be made in part or all of the components.
